(19) United States
(12) Patent Application Publication
(10) Pub. No.: US 2025/0035268 A1
(43) Pub. Date: Jan. 30, 2025

(54) CONTAINER WITH VALVE FOR STORING, DISPENSING AND TRANSPORTING AIRCRAFT FUEL ADDITIVES, ASSOCIATED KIT AND METHOD

(71) Applicants: EUROMECCANICA MAZZER S.R.L., Terracina (LT) (IT); POLCOMIX ITALIA SRL, Torino (TO) (IT)

(72) Inventors: Alberto MAZZER, Terracina (LT) (IT); Olivier Guillaume François PERDRIEL, Torino (TO) (IT)

(21) Appl. No.: 18/715,238

(22) PCT Filed: Nov. 23, 2022
(86) PCT No.: PCT/IB2022/061345

§ 371 Date: May 31, 2024

(30) Foreign Application Priority Data
Dec. 1, 2021 (IT) 102021000030386

(51) Int. Cl. F17C 13/04; B01F 25/00; B01F 35/21; B01F 35/51; B01F 101/00; B64D 37/00; F16K 11/00; F16K 37/00; F17C 3/00

(52) U.S. Cl. CPC F17C 13/04; B01F 25/1051; B01F 35/2112; B01F 35/51; B64D 37/005; F16K 19/00; F16K 37/0025; F17C 3/00; B01F 2101/503; F17C 2201/032; F17C 2201/058; F17C 2203/0634; F17C 2203/0692; F17C 2205/0323; F17C 2205/058; F17C 2265/025; F17C 2265/065; F17C 2270/0189

(57) ABSTRACT

Container (100) with valve for storing, dispensing and transporting aircraft fuel additives, which allows speeding up and simplifying the mixing and refueling process, through numerous smart functions and an innovative valve system (40). The invention uses recyclable materials, reduces the mixing action time and/or the need to mix large quantities of liquids, guarantees the safety of things and people in the work area and is easily transportable due to its ergonomic and compact shape. The device comprises a body (10) capable of resisting impacts; a hermetic sealing system (12) to protect the contents; a coupling system (16); a sensor or a level gauge (17) connected, possibly where the working environment allows it, to an alarm system (14), suitable to warn the operator of the exhaustion of the additive by means of a luminous LED signal.

### FIELD OF THE INVENTION

The present invention relates to the field of containment and dispensing devices intended for the storage and transport of a suitable additive, in particular for the refueling of aircraft fuel. Even more specifically, the object of the present invention is aimed at speeding up and simplifying the mixing and refueling process, through numerous smart functions and an innovative valve system.

### PRIOR ART

New engine technologies, such as diesel engines with the common rail system, high pressure fuel injection and jet engines for avionics use, are very efficient, but are very sensitive to fuel quality. Therefore, there are advantages to using a fuel that contains additives; in particular additives to improve fuel distribution in the engine, additives to improve engine performance and additives to improve the stability of engine operation and those necessary to maintain the operating conditions of the tanks avoiding or delaying the formation of deposits, fungi and algae deleterious for the normal functioning of engines. The discussion can also be extended to the refueling of aircraft.

It is known that there are systems that allow these additives to be introduced into the fuel, which are based on a large capacity tank of at least 2 or 3 liters of volume that contains the additive reserve, which is positioned in areas close to the fuel tank.

The current strategies for dosing additives, moreover, also require high precision dosing pumps, these must be ordered through a specific and additional electronic unit (or ECU). The metering unit must be handled with care to ensure an exact additive-fuel ratio to avoid premature clogging due to minerals being collected in the tank. Normally, when the fuel level rises in the tank after adding fuel, the computer tells the pump how much additive to inject into the tank to maintain a constant concentration of additive in the fuel tank.

An example is provided by patent application FR2668203. The patent describes a device for introducing an additive into the fuel tank useful for regenerating the particulate filter. This technical solution has the drawback of requiring a tank of significant volume for the additive as well as an electronic system for measuring the refueling of the fuel tank. Furthermore, this technical solution increases the weight of the mixer and therefore the fuel consumption.

Another example is that provided by patent application MX2013008962A. The invention relates to a device for dispensing a liquid additive in a fuel circulation circuit for an internal combustion engine. Said device comprises a tank for the liquid additive which allows an additive to be distributed in the fuel circulation circuit by means of a distributor. The latter comprises an additive chamber in communication with the fuel circulation circuit and at least a movable wall, which maintains equal pressure between the additive in the tank and the fuel in the additive chamber.

The solutions presented, although extremely precise, have high costs.

The object of the present invention is to overcome this problem by proposing a device which advantageously allows all aircraft refueling operations to be sped up and made easier, exploiting multiple smart functions. Since there are no systems on the market for containing, transporting and dispensing additives dedicated to mixing units that are easy to use and which guarantee a known and constant dosage, the present invention, by virtue of its small and ergonomic shape, not only allows a practical use/transport, but also allows one to considerably reduce costs; this latter factor is further guaranteed since the components are totally recyclable and the system is very easy to use, also not requiring specialized operators.

### DESCRIPTION OF THE INVENTION

According to the present invention, a container with a valve for storing, dispensing and transporting aircraft additives is produced, which allows the dispensing of certain additives, through an easy and simple system for the operator on site and/or the company that benefits from it.

The present invention consists of a body resistant to impacts and pressures, as well as to possible chemical attacks deriving from their presence and use during the refueling steps, in such a way as to keep the additive present inside unaltered.

The body is advantageously produced in recyclable materials and with an ergonomic shape; this latter feature allows for easy transport even within the aircraft and/or confined spaces.

In one of the preferred embodiments of the invention, the body may comprise a pressurization and containment bag inside it, which further improves the separation of the additive from the body itself, making it completely recyclable and advantageously safe.

Said pressurization and containment bag, in addition to being advantageously extractable from the coupling system with safety valve, ensures that additive residues remain therein, also produced entirely in recyclable material to allow correct disposal thereof.

At one of the ends of the body of the present invention there is a coupling system with valve which allows the connection for the transfer of the additive in a firm and safe manner, and for the hermetic closure of the container.

The container with valve for storage, dispensing and transport of additives includes an innovative connection valve that has several moving and fixed parts, as well as the necessary seals. The valve is a device that mainly consists of two valves: container valve and mixer valve. These valves are one installed on the mixer and the other installed on the coupling system of the container. The main feature of the two valves is that they are complementary and exclusively combinable without having to be connected to other devices. The processing tolerances and the adequate gaskets, whose seats have been specially designed, allow the additive to flow from the container to the mixer valve, passing through the channels generated during connection.

In a preferred embodiment of the present invention, the container comprises compression-loaded springs installed in the obtained channels, said springs being suitable to exert the pressure required to close/open each surface functional to the containment and the through-flow of the fluid transported by means of the container.

The method of operation of the aforementioned valve system is presented below, in such a way that once coupled they allow the additive to pass from the container to the mixer.

The method has a first step in which the operator couples the two valves, placing the fixed shutter of the container on the fixed shutter of the mixer.

The two shutters form an abutment point for both valves. The operator, in this step, is facilitated by some seats for the alignment of the two valves. After aligning the valves and applying slight pressure, the operator stabilizes the valves and, therefore, also the container, ensuring that it is fixed.

The method has a second step in which a further pressure exerted by the operator allows the movable shutter of the container to slide inside the casing of the mixer valve and generate a channel that fills with additive without, however, passing through the valve of the mixer. Subsequently, in the third step, the operator rotates the container and at the end of the rotation, the movable shutter of the mixer, pushed by the slider to an abutment point of the slider (both belonging to the mixer valve), is completely retracted, while the movable shutter of the container is fully extended inside the casing of the mixer valve: all the passage channels thus created are completely open and the additive flows from the container to the mixer.

Once the additive has been dispensed, the operator rotates the container in the opposite direction and disengages the movable shutter of the mixer which, returning to the rest position, creates a vacuum thereby drawing any liquid left in the channel. This sliding, with the consequent drawing of liquid, excludes the formation of any residual drops on the external surface of the mixer valve. By pulling out the container and its valve from the container, the movable container shutter returns to its original position. In this step, the gaskets present inside “scrape” any residual additive from the walls of the fixed shutter of the container bringing them back inside it; in this way, drops and leaks are avoided also on the side of the container. The invention comprises an openable/reclosable hermetic sealing system with the aim of isolating the additive contained and not allowing it to escape randomly or accidentally, even through a container valve with the task of keeping both the hermetic sealing system stable and secure and the tightness of the body during the dispensing of the additive.

The container with valve for storing, dispensing and transporting additives may possibly have inside it a mechanical sensor (for example a feeler) or a level gauge, installed to ensure the display of information relating to the quantity of additive remaining inside the container body and therefore allow the operator on site a prompt response. Where possible, and allowed by the work environment and by the type of fluids to be mixed, the use of electronic components is envisaged for the transmission of information and possible remote monitoring, if necessary. Depending on the destination and the environment of use, the invention may be provided with an alarm system applied to the body by means of a common mechanical or magnetic restraint device. The possible alarm system is connected to a connection module, with or without wires, which allows the communication of the data detected by said level sensor to at least an alarm system: in this way, an LED light signal is possibly emitted which warns the operator on site of the imminent exhaustion of the additive inside the body.

In one of the preferred embodiments, the device may also provide a sight glass with the purpose of making the additive level visible inside the body in an additional and/or alternative way to the sensor or level gauge.

The invention may a QR code on the external surface of the body, which may be scanned by the operator through the camera of any mobile device; after scanning this QR code, entirely made of material resistant to fluids including the additive itself, the operator can instantly access all the information relating to the additive and the container with valve for storing, dispensing and transporting additives, such as expiration date, date of manufacture, etc.

The QR code may also be printed by means of a LASER source directly on the body and preferably in a position that is easily identifiable.

Finally, the invention in one of the preferred embodiments may comprise an RFID tag, readable by suitable devices provided with RFID data readers supplied to the operators, containing and referring to the information of the product and its content.

The advantages offered by the present invention are clear in the light of the above description and will be even clearer from the accompanying figures and the related detailed description.

### DESCRIPTION OF THE FIGURES

The invention will hereinafter be described in at least a preferred embodiment thereof by way of non-limiting example with the aid of the accompanying figures, in which:

FIG. 1 shows an external front view of the container with valve for storing, dispensing and transporting aircraft fuel additives 100 with hermetic seal applied;

FIG. 2 shows a vertical section view of the internal components of the container with valve for storing, dispensing and transporting aircraft fuel additives 100 in use;

FIG. 3 shows a front view of the “multiple manifold-like” system 200 possibly included in the kit associated with the container with valve for storing, dispensing and transporting aircraft fuel additives 100;

FIG. 4 shows a front view of the container with valve for storing, dispensing and transporting aircraft fuel additives 100, when it is engaged on a “multiple manifold-like” system 200 while a refueling is carried out through a mixer 300;

FIG. 5 illustrates a section of the valve system 40 and its components, in the rest step.

FIG. 6 schematically shows the positioning of said springs 50-50′-50″ loaded by compression.

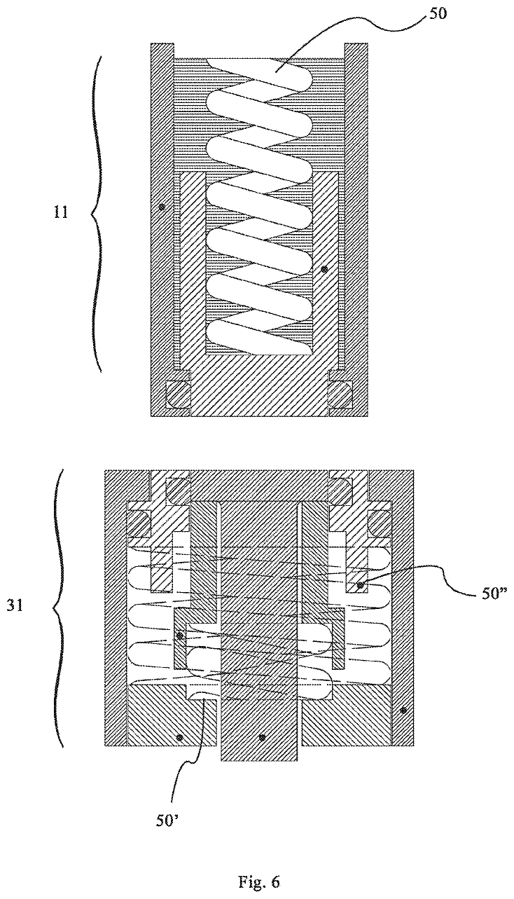

### DETAILED DESCRIPTION OF THE INVENTION

The present invention will now be described purely by way of non-limiting or binding example with the aid of the figures, which illustrate some embodiments relative to the present inventive concept.

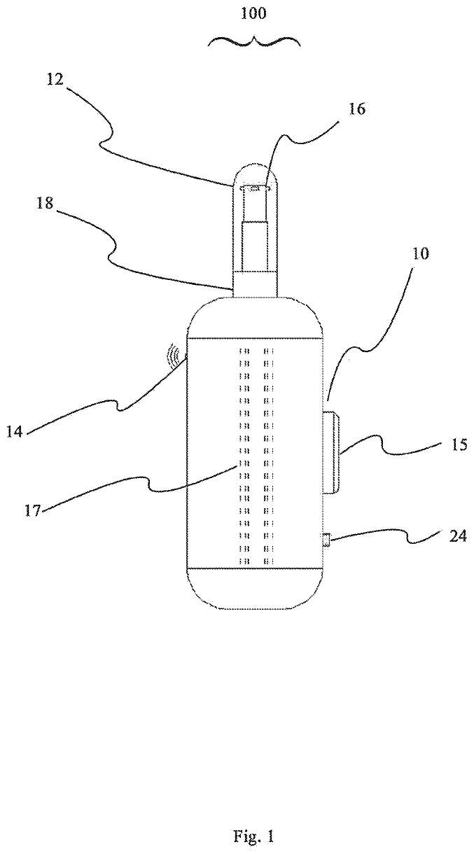

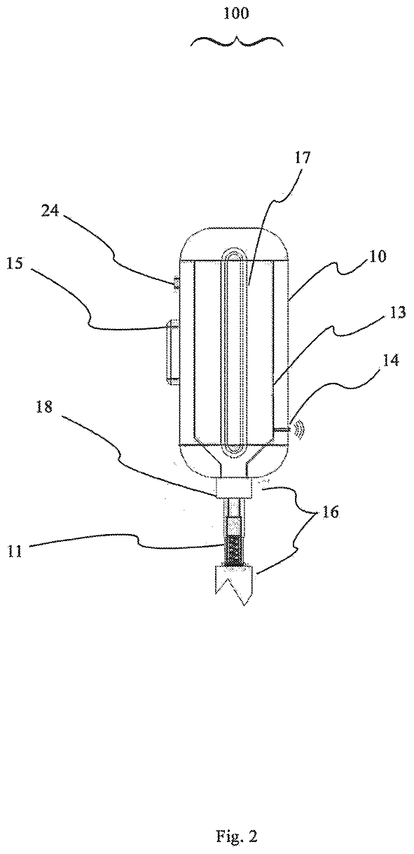

With reference to FIGS. 1 and 2, the main components of the container with valve for storing, dispensing and transporting aircraft fuel additives 100 are shown. In particular, FIG. 1 shows a front view of the external components of the container with valve for storing, dispensing and transporting aircraft fuel additives 100; FIG. 2 shows the internal components through a sectional view of the container with valve for storing, dispensing and transporting aircraft fuel additives 100, during use.

The invention has a body 10 suitable to contain and isolate, directly or indirectly, by means of a suitable pressurization and containment bag 13, the additives and also to ensure a protected and safe environment for said substances. Said body 10 has an ergonomic and compact shape which allows it to be easily transported and is made of recyclable material. Said body 10 is provided with a compensation valve 24 whose function is to let air in without letting the additive escape.

Inside the body 10 there is a level sensor or gauge 17 suitable for detecting the quantity of additive present. Said level sensor, feeler or gauge 17 may also detect the shape of said pressurization and containment bag 13 and, consequently, where permitted by the environment, by the use and by the features of the type of fluid, transmit the information by means of a possible connection module with or without wires, by way of example but not limited to a Wi-Fi connection, to the possible alarm system 14 which, by means of a visual, luminous or acoustic signal, warns the operator about the state of consumption of the additive. Inside said body 10 there is said pressurization and containment bag 13 whose purposes are to provide further containment for the additive and to facilitate the suction of the fluid.

On the surface of said body 10 there is positioned the possible alarm system 14, connected with a connection module with or without wires, by way of non-limiting example via the Wi-Fi network, to said level sensor or gauge 17, suitable to inform the operator on site of the quantity of additive inside said body 10. Said alarm system 14, if any, warns by means of a possible LED light signal and/or a possible sound signal of the progressive depletion of the additive.

Said body 10 has a coupling system 16 installed at one end 18, suitable to keep the connection between said body 10 and a refueling system (mixer)stable when dispensing the additive into the fuel stream.

The invention has at least a hermetic sealing system 12 which may be opened/closed, which allows the safe isolation of the additive inside said body 10.

The container with valve for storing, dispensing and transporting aircraft fuel additives 100 comprises a sight glass 15 suitable to be queried at any time by the operator to check the level of the additive inside the body 10; said sight glass 15 allows adding a further level of control in addition to the sensor or level gauge 17. In a specific embodiment for applications in particularly dangerous and/or explosive environments, provision is made for the construction of a container made of transparent material or which allows seeing directly, moment by moment, what the level of fluid consumption inside the container is.

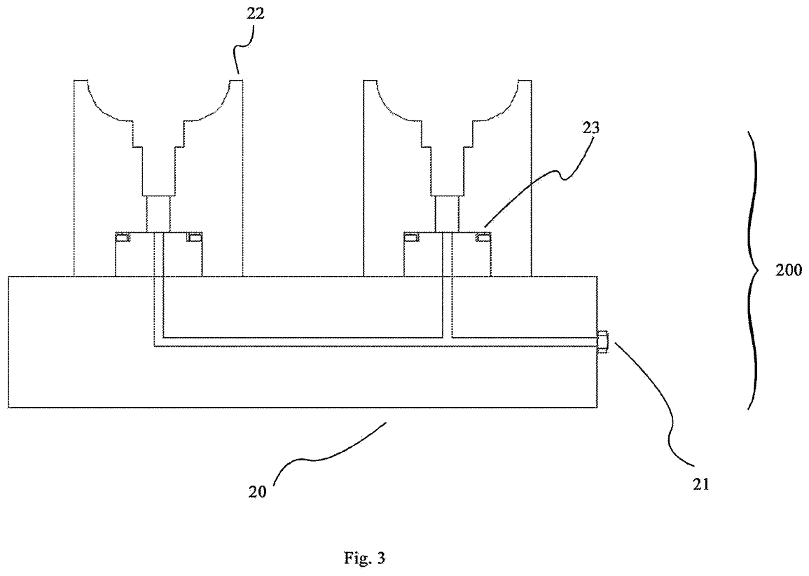

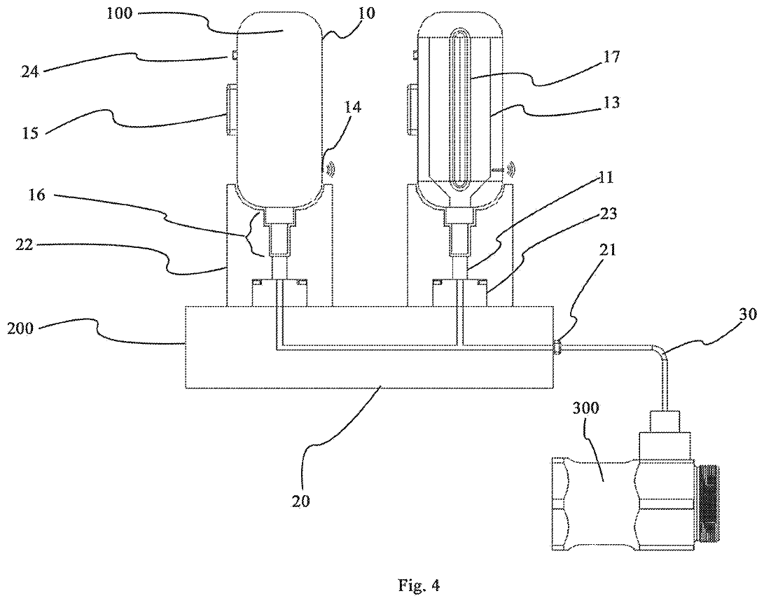

With reference to FIGS. 3 and 4, they show the main components of a kit associated with a container with valve for storing, dispensing and transporting aircraft fuel additives 100. FIG. 3 shows a section of the “manifold-like” system 200 with its components. Said manifold may house a plurality of containers or in any case a number of containers such as to satisfy the requirements of the specific application.

FIG. 4 shows a section of the container with valve for storing, dispensing and transporting aircraft fuel additives 100, engaged on the “manifold-like” system 200 during refueling through a mixer 300.

The kit comprises a “manifold-like” system 200 consisting of: at least a manifold body 20, suitable for collecting the additive; at least an outlet mouth with safety valve 21 adapted to allow and block the release of the additive or the application of an extensible/fixed and flexible/rigid conduit 30; at least two coupling seats 23, so as to allow the stable and safe screwing of the coupling system 16 even with numerous containers with valves for storing, dispensing and transporting aircraft fuel additives 100 used simultaneously; at least a support system 22, suitable for ensuring the stability of the containers with valve for storing, dispensing and transporting aircraft fuel additives 100 during the collection and/or release step.

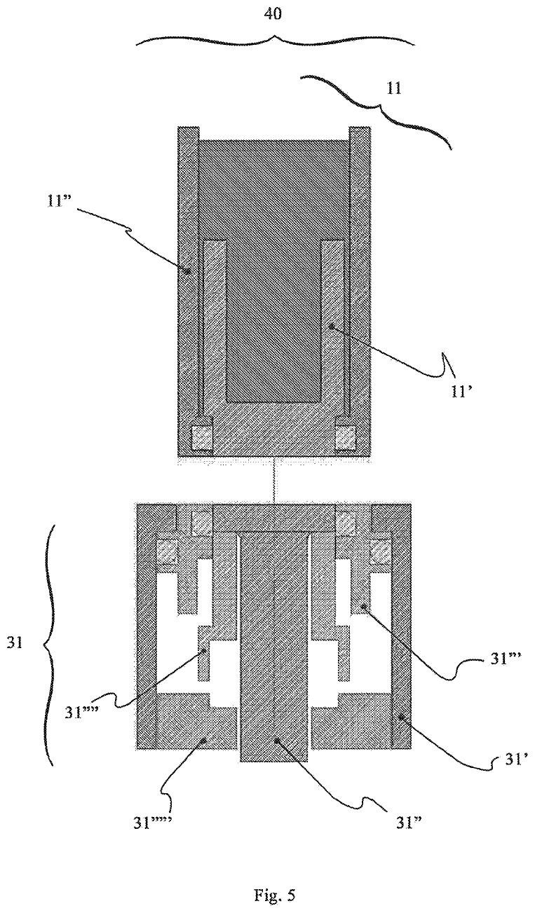

FIG. 5 shows a section of the internal components of the valve system 40 in the rest step. The valve system comprises: at least a valve of the mixer 31, engaged at a mixer 300 and a valve of the container 11, engaged at said coupling system 16, so as to allow the transfer of the additive from said container with valve for storing, dispensing and transporting aircraft fuel additives 100 to said mixer 300; said valve of the mixer 31 and said valve of the container 11 being mating exclusively to each other; said valve of the container 11 being adapted to retain the additive inside the body 10; said valve of the container comprising a fixed shutter of the container 11″, adapted to come into contact with said valve of the mixer 31, and a movable shutter of the container 11′, adapted to mobilize the internal components of said valve of the mixer 31, entering the casing 31′ of said valve of mixer 31 in such a way that the additive enters said valve of mixer 31 creating channels; said valve of the mixer 31 being adapted to allow the passage of the regulated flow of additive received by said valve of the container 11 inside said mixer 300; said valve of the mixer 31 being provided with a fixed shutter of the mixer 31″, adapted to come into contact with said movable shutter of the container 11′, a slider 31′41 adapted to be mobilized by said fixed shutter of the container 11″, by means of pressure carried out by an operator on site, in such a way as to set in turn the movable shutter of the mixer 31″″ until it impacts against an abutment of the slider 31′″″, allowing the entry of the additive flow through the channels generated by such movements.

Finally, it is clear that modifications, additions or variants may be made to the invention described thus far which are apparent to those skilled in the art, without departing from the scope of protection that is provided by the appended claims.

1. Container (100) with valve for storing, dispensing and transporting aircraft fuel additives characterized in that it comprises:
a body (10) made of a material resistant to impacts, pressure and possible attacks by any chemical agent; said body (10) being suitable to contain a predetermined amount of at least a chemical additive to be mixed with the aircraft fuel; said body (10) having a coupling end (18) suitable to allow the use and the transportation by an operator in loco;
at least a coupling system (16), engaged at the coupling end (18) of said body (10), suitable to ensure stable but reversible connection of said body (10) to an external supply system for conveying the additive contained in said body (10) into the dispensed fuel flow;
at least a valve system (40) comprising a valve of the mixer (31), engaged at the mixer (300) and a valve of the container (11), engaged at said coupling system (16), so as to make the additive move from said body to said mixer; said valve of the mixer (31) and said valve of the container (11) being complementary and exclusively combinable, so that the use of one necessarily requires the presence of the other; said valve of the container (11) suitable to hold the additive inside the body (10); said valve system (40) suitable to allow an adjustment of the flow of the additive from the container with storage valve, dispensing and transporting aircraft fuel additives (100) in the mixer (300); said valve of the container (11) consisting of a fixed shutter of the container (11″), suitable to come into contact with said valve of the mixer (31), and a movable shutter of the container (11′), suitable to move the internal components of said valve of the mixer (31), entering into the casing (31′) of said valve of the mixer (31) so that the additive enters into said valve of the mixer (31) by creating channels; said valve of the mixture (31) suitable to allow the through-flow of the adjusted flow of additive received from said valve of the container (11) into said mixer (300); said valve of the mixture (31) being provided with a fixed shutter of the mixer (31″), suitable to come into contact with said movable shutter of the container (11′), a slider (31″′) suitable to be moved by said fixed shutter of the container (11″), through pressure exerted by an operator in loco, so as to in turn move the movable shutter of the mixer (31″″) until it impacts against an abutment of the slider (31′″″), allowing the entry of the additive flow through the channels generated by such movements;
at least a hermetic sealing system (12), which can be opened/closed and engaged at said coupling system (16), suitable to hermetically insulate the additive in said body (10);
at least a compensation valve (24), engaged on said body (10), suitable to balance the internal pressure of the container during use;
at least a level sensor or gauge (17), installed in said body (10), suitable to detect the level of the additive present in said body (10);
at least a wired or wireless connection module, where allowed by the environment of use of the device, connected to said level sensor or gauge (17), suitable to allow the communication of the detected datum from said level sensor or gauge (17) to at least a possible alarm system (14);
at least one said alarm system (14), engaged on said body (10) by means of a common mechanical or magnetic device and being connected by means of said possible connection module to said level sensor or gauge (17), suitable to be activated should there be detected the imminent exhaustion of the additive through a possible acoustic signaling device and/or luminous LED; said alarm system (14) being suitable to be activated/deactivated, by means of a microswitch, so as to allow the use thereof only under conditions where the operating environment allows it.

2. Container (100) with valve for storing, dispensing and transporting aircraft fuel additives, according to the preceding claim 1, characterized in that said body (10) is made of recyclable materials and it produced in ergonomic and compact form, so as to allow easy transportation/use thereof.

3. Container (100) with valve for storing, dispensing and transporting aircraft fuel additives, according to claim 1 characterized in that said body (10) is transparent so as to allow the operator to check the level of additive therein.

4. Container (100) with valve for storing, dispensing and transporting aircraft fuel additives, according to claim 1, characterized in that said body (10) has a sight glass (15), which allows the operator to check the level of additive therein additionally/alternatively to the level sensor or gauge (17).

5. Container (100) with valve for storing, dispensing and transporting aircraft fuel additives, according to claim 1, characterized in that it comprises a QR code, engaged on the outer surface of said body (10), suitable to be scanned using mobile devices; said QR code being suitable to make the container traceable and provide information relating thereto.

6. Container (100) with valve for storing, dispensing and transporting aircraft fuel additives, according to claim 5, characterized in that said QR code is printed on a medium made of material resistant to additives and fuel.

7. Container (100) with valve for storing, dispensing and transporting aircraft fuel additives, according to claim 5, characterized in that said QR code is printed using a laser printer directly on said body (10) and in a visible position during use.

8. Container (100) with valve for storing, dispensing and transporting aircraft fuel additives, according to claim 1, characterized in that it comprises an RFID label, installed on the surface of said body (10), suitable to be read by RFID readers so as to allow immediate recognition.

9. Container (100) with valve for storing, dispensing and transporting aircraft fuel additives, according to claim 1, characterized in that it comprises compression-loaded springs (50-50′-50″) installed in the obtained channels, said springs (50-50′-50″) being suitable to exert the pressure required to close/open each surface functional to the containment and the through-flow of the fluid transported by means of the container.

10. Container (100) with valve for storing, dispensing and transporting aircraft fuel additives, according to claim 1, characterized in that said body (10) contains a pressurization and containment bag (13) therein, suitable to contain the additive providing further safety during refueling, allowing the recycling thereof and facilitating the suctioning of the fluid in the mixture (300); said pressurization and containment bag (13) suitable to be removed from said body (10) by opening said coupling system (16), ensuring that additive residues remain therein; said pressurization and containment bag (13) is suitable to provide a dynamic preload to the fluid to be mixed so as to facilitate the suctioning thereof from the mixer; said pressurization and containment bag (13) suitable to be contracted, with the ensuing drop of the level of the liquid, by said compensation valve (24).

11. Container (100) with valve for storing, dispensing and transporting aircraft fuel additives, according to claim 10, characterized in that said pressurization and containment bag (13) inside the body (10), suitable to contain the additive, is made of recyclable material.

12. Kit associated with a container (100) with valve for storing, dispensing and transporting aircraft fuel additives characterized in that it comprises:
at least a container (100) with valve for storing, dispensing and transporting aircraft fuel additives, according to claim 1;
at least a pressurization and containment bag (13).

13. Kit associated with a container (100) with valve for storing, dispensing and transporting aircraft fuel additives characterized in that it comprises:
at least a container (100) with valve for storing, dispensing and transporting aircraft fuel additives, according to claim 1;
at least a “manifold-like” system (200) suitable to allow the simultaneous use of several containers (100) during refueling.

14. Kit associated with a container (100) with valve for storing, dispensing and transporting aircraft fuel additives, according to claim 13, characterized in that said “manifold-like” system (200) comprises:
at least a manifold body (20), suitable to convey the additive;
at least two seats (23) for coupling on said manifold body (10), shaped so as to allow the correct insertion of said coupling system (16);
at least an outlet mouth with safety valve (21) engaged on a wall of the manifold body (20), suitable to allow the adjustable outflow of the additive or the application of an extensible/fixed and flexible/rigid duct (30) suitable to introduce said additive into an external mixer (300);
at least a support system (22), suitable to ensure the stability of the containers (100) during the collection of said additive in said manifold body (20) and/or during the release of said additive in said mixer (300) through said outlet mouth with safety valve (21).

15. Kit associated with a container (100) with valve for storing, dispensing and transporting aircraft fuel additives, according to claim 13, characterized in that it comprises an alarm system (14) suitable to warn the operator of the imminent exhaustion of the additive by means of a sound signal; said sound alarm system (14) being connected to a wired or wireless connection module.

16. Method for the operation of a container or a kit for a container (100) with valve for storing, dispensing and transporting aircraft fuel additives according to claim 1 and characterized in that it comprises the following steps:
the operator couples the valve of the container (11) and the valve of the mixer (31) by pressing, placing the movable shutter of the container (11′) on the fixed shutter of the mixer (31″), facilitated by alignment seats and ensuring the fixing;
the operator exerts a further pressure allowing the fixed shutter of the container (11″) to slide in the casing (31′) of the valve of the mixer (31) and generate a channel which is filled with the additive awaiting the flow through the valve of the mixer;
the operator rotates the container (100) with valve for storing, dispensing and transporting aircraft fuel additives up to the end of the rotation allowed so that the movable shutter of the valve of the mixer (31″″), pushed by the slider (31′″) up to the abutment of the slider (31″′″), is fully retracted, and the fixed shutter of the container (11″) is fully extended inside the casing (31′) of the valve of the mixer (31); the through-flow channels, thus created, are fully open and the additive flows out from the container (100) with valve for storing, dispensing and transporting aircraft fuel additives to the mixer (300);
once through with the dispensing of the additive, the operator rotates—in the reverse direction—the container (100) with valve for storing, dispensing and transporting aircraft fuel additives and disengages the movable shutter of the mixer (31″′) which, returning to the inoperative position, creates a depression drawing back the possible liquid left in the channel; the flowing and ensuing draw back of liquid prevents the formation of possible residual drops on the outer surface of the valve of the mixer (31);
the operator removes the container (100) with valve for storing, dispensing and transporting aircraft fuel additives and the relative valve of the container (11), the movable shutter of the container (31″″ and 31″′) returns to the initial position thereof.
